(19) United States
(12) Patent Application Publication
(10) Pub. No.: US 2003/0142084 A1
(43) Pub. Date: Jul. 31, 2003

(54) Embedded and programmable gamma correction circuit and method

(76) Inventors: Peter Chang, Taipei (TW); Welton Shih, Hsien Tien (TW); Shinichi Tanaka, Tokyo (JP)

Correspondence Address: TEXAS INSTRUMENTS INCORPORATED, P O BOX 655474, M/S 3999, DALLAS, TX, 75265

(21) Appl. No.: 10/062,806

(22) Filed: Jan. 31, 2002

(51) Int. Cl. G09G 5/00

(52) U.S. Cl. 345/204

(57) ABSTRACT

A gamma correction circuit (224) and method of gamma correction. The gamma correction circuit (224) comprises a plurality of digital-to-analog converters (DACs), each DAC having an output, and a register (226) with an output coupled to provide input information to each of the DACs. The output of each of the DACs provides an analog voltage which can be used for gamma correction. A source driver (222) is coupled to each of the DAC outputs. The gamma correction circuit (224) and the source driver (222) may be integral to the same integrated circuit chip.

### TECHNICAL FIELD

This invention relates generally to display systems, and more particularly to gamma correction for small form factor (SFF) display systems.

### BACKGROUND

Electronic devices and computers have grown in popularity recently, particularly in view of the recent developments in wireless devices and systems and the Internet, as examples. The trend towards the miniaturization of devices, computers and electronic components has resulted in many devices being made smaller and more portable, with longer battery life. This new generation of electronic devices and systems is often referred to in the art as “Small Form Factor” (SFF), referring to the decreased size of the devices and components.

Display systems for SFF devices and systems prove particularly challenging for designers due to their decreased size and complexity. SFF display systems will be popular in the future, in applications such as digital still cameras, video cameras, personal digital assistants (PDAs), mobile phones, and automobile television sets, as examples.

Gamma is a non-linear effect of the human visual system to brightness perception and the electronic display system property. For example, the liquid crystal display (LCD) transparency versus applied voltage curve is non-linear. The human brightness perception versus real light intensity is also non-linear.

Electronic displays require gamma correction, which corrects the non-linear effects of the human visual system. Without gamma correction, a display image would appear to a viewer as washed-out or too dark, with poor color rendition and unbalanced gray scales. The quality of the image suffers due to the effects of gamma, if gamma is not corrected. Gamma correction controls the overall brightness of an image and the ratios of red to green to blue. With gamma correction designed correctly, a display should accurately reflect the image input.

### SUMMARY OF THE INVENTION

Embodiments of the present invention are advantageous in providing an embedded, programmable gamma correction circuit that is particularly useful in SFF displays and display systems.

Disclosed is a gamma correction circuit including a plurality of digital-to-analog converters (DACs), each DAC having an output. The circuit also includes a register with an output coupled to provide input information to each of the DACs, wherein the output of each of the DACs provides an analog voltage which can be used for gamma correction.

Also disclosed is a display system adapted to receive an output from a video image source. The display system includes a gamma correction circuit including a plurality of DACs coupled to the video image source output, with each DAC having an output. The gamma correction circuit includes a register with an output coupled to provide input information to each of the DACs, wherein the output of each of the DACs provides an analog voltage which can be used for gamma correction. The display system includes a source driver coupled to the output of each DAC, the source driver having an output, and a display coupled to the source driver output.

Further disclosed is a method of correcting gamma from video image source having an output to a display having an input, comprising coupling a gamma correction circuit comprising a plurality of DACs to the video image source output, each DAC having an output. The gamma correction circuit includes a register with an output coupled to provide input information to each of the DACs, wherein the output of each of the DACs provides an analog voltage which can be used for gamma correction. The method includes coupling a source driver to the output of each DAC and the display input.

Advantages of embodiments of the present invention include providing a cost-effective and size-effective means of providing gamma correction. The gamma correction circuit may be highly integrated with other circuit components of the display system: for example, the gamma correction circuit and a source driver may be integral to the same single integrated circuit chip. The circuit and method are particularly advantageous when used in SFF display systems. The gamma correction circuit provides a flexible solution, with the DAC output voltages being programmable.

### BRIEF DESCRIPTION OF THE DRAWINGS

The above features of embodiments of the present invention will be more clearly understood from consideration of the following descriptions in connection with accompanying drawings in which:

FIG. 1 illustrates a prior art gamma correction circuit comprising a string of resistors;

FIG. 2 shows a block diagram of a gamma correction circuit in accordance with an embodiment of the present invention implemented in a display system;

FIG. 3 shows a more detailed view of a portion of the gamma correction circuit shown in FIG. 2;

FIG. 4 illustrates a more detailed view of a portion of the gamma correction circuit shown in FIG. 2, showing a chip block diagram of the timing controller and source driver;

FIG. 5 shows a graph of a gamma correction curve in accordance with an embodiment of the invention; and

FIG. 6 illustrate the digital gamma correction circuit in accordance with an embodiment of the invention, comprising ten programmable DACs that independently generate ten reference voltages.

Corresponding numerals and symbols in the different figures refer to corresponding parts unless otherwise indicated. The figures are drawn to clearly illustrate the relevant aspects of the preferred embodiments and are not necessarily drawn to scale.

### DETAILED DESCRIPTION OF PREFERRED EMBODIMENTS

A prior art gamma correction circuit will be discussed, followed by a description of some preferred embodiments of the invention and some advantages thereof.

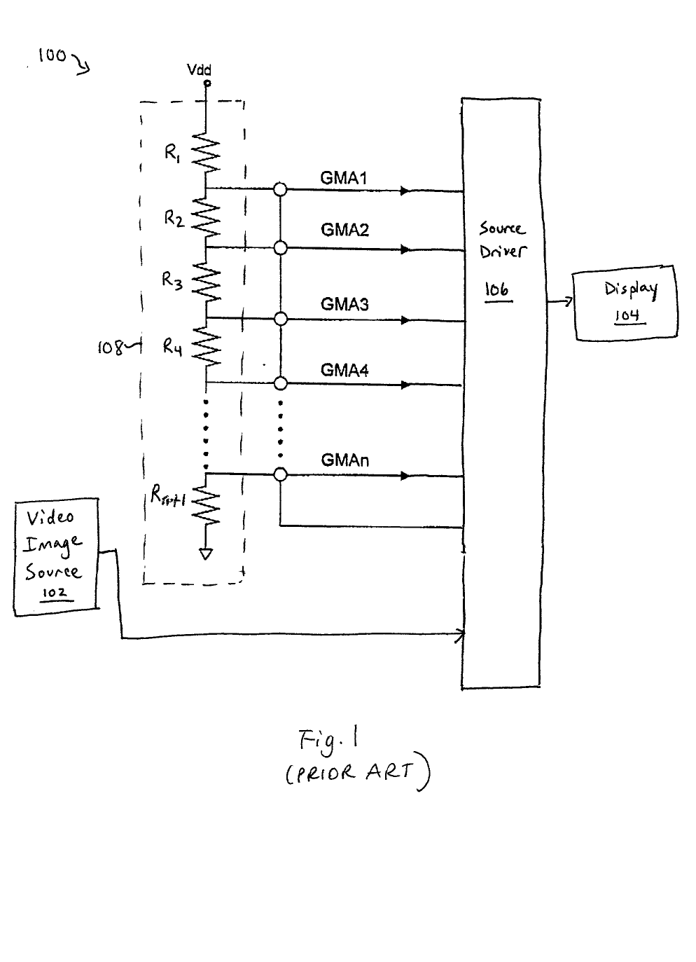

FIG. 1 illustrates a prior art display system 100 comprising a gamma correction circuit 108 comprising a string of resistors R₁, R₂, R₃, R₄, to Rₙ₊₁. The resistor string 108 is divided non-uniformly to generate a non-linear distribution of reference voltages GMA1, GMA2, GMA3, GMA4 to GMAn, in order to model a nonlinear effect. A video image source 102 is coupled to a source driver 106. The source driver 106 uses the reference voltages GMA1, GMA2, GMA3, GMA4 to GMAn to correct the video signal from the video image source 102, and provide a more accurate video image to the display 104.

A problem with the prior art gamma correction circuit 108 is that typically the source driver 106 is located on an integrated circuit, and resistors R₁, R₂, R₃, R4, to Rₙ₊₁ must be mounted on a circuit board (not shown) that the source driver integrated circuit is typically mounted on. Resistors R₁, R₂, R₃, R4, to Rₙ₊₁ are large and require a large amount of surface area on the board. Furthermore, an external power supply, voltage Vdd, is required for reference power on the board. A gamma correction circuit 108 comprising resistors R₁, R₂, R₃, R4, to Rₙ₊₁ is impractical for small size equipment such as SFF devices. Furthermore, the voltages GMA1, GMA2, GMA3, GMA4 to GMAn are fixed unless the resistors R₁, R₂, R₃, R4, to Rₙ₊₁ on the board are replaced.

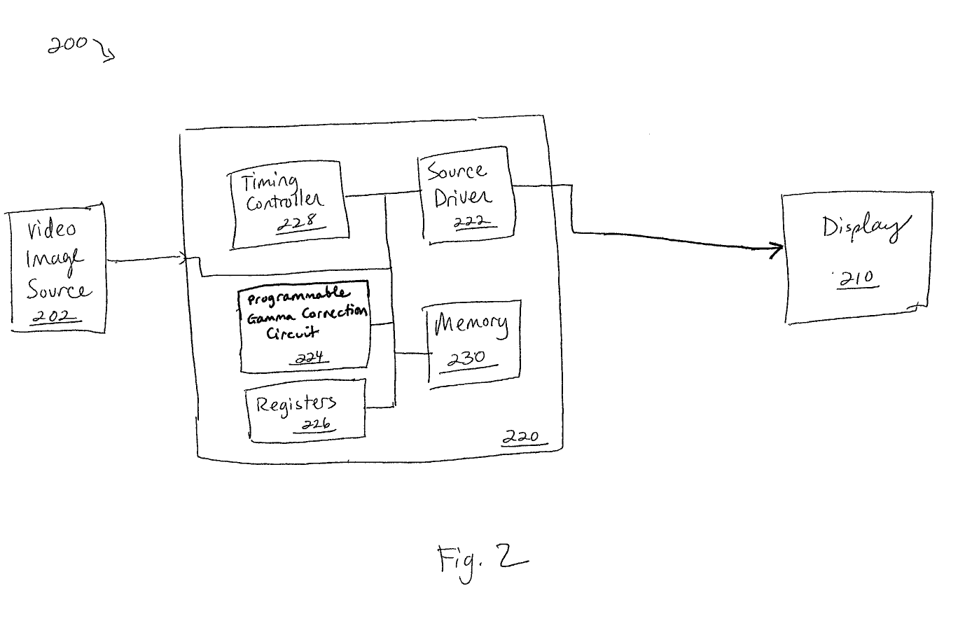

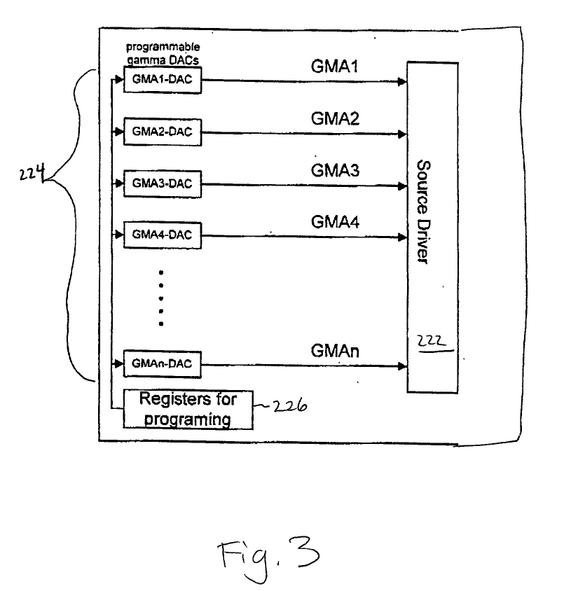

Embodiments of the present invention provide an on-chip programmable gamma correction circuit that is particularly advantageous for small-scale display systems such as SFF. FIG. 2 shows a block diagram of a gamma correction circuit 224 in accordance with an embodiment of the present invention implemented in a display system 200. The display system 200 comprises a video image source 202 having an output, and the gamma correction circuit 224 includes a plurality of digital-to-analog converters (DACs) (shown in FIG. 3) coupled to the video image source 202 output. Each DAC has an output, and the gamma correction circuit includes a register 226 with an output coupled to provide input information to each of the DACs. The output of each of the DACs provides an analog voltage GMA1, GMA2, GMA3, GMA4 to GMAn which can be used for gamma correction.

The display system 200 may include a source driver 222 coupled to the output of each DAC, the source driver 222 having an output. The display system 200 may also include a display 210 coupled to the source driver 222 output. A timing controller 228 may be coupled to the DACs 224. A memory 230 may be coupled to the registers 226. The registers 226 may store six bits for each analog voltage GMA, for example.

Preferably, the gamma correction circuit 224 and the source driver 222 are integral to the same integrated circuit chip. This is advantageous in that space in the video system 200 is conserved. The display 210 may comprise a digital still camera, digital video camera, personal digital assistant (PDA), mobile phone, automobile television set, or liquid crystal (LCD) display, as examples.

FIG. 3 shows a more detailed view of a portion of the gamma correction circuit shown in FIG. 2. The programmable gamma correction circuit 224 preferably comprises a plurality of programmable gamma DACs GMA1-DAC, GMA2-DAC, GMA3-DAC, GMA4-DAC, to GMAn-DAC, as shown. The programmable DACs each generate a reference voltage GMA1, GMA2, GMA3, GMA4 to GMAn which can be used for gamma correction, e.g., and input to the source driver 222, as shown.

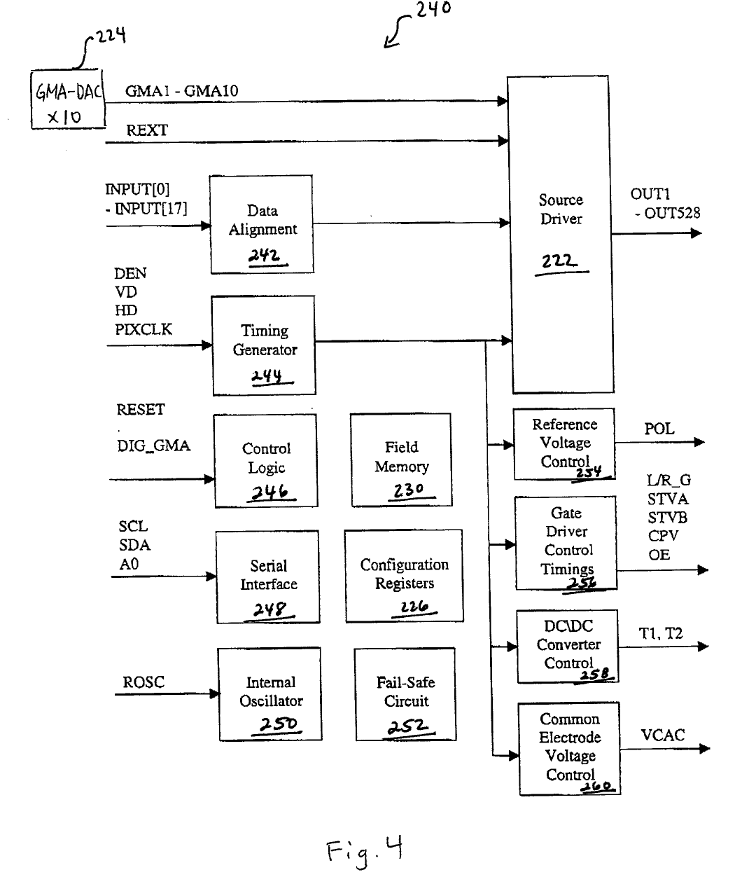

FIG. 4 illustrates a more detailed view of a portion of the gamma correction circuit shown in FIG. 2, showing a preferred chip block diagram 240 of the timing controller and source driver. Preferably, all components shown are integral to a single integrated circuit chip, although alternatively, some components may be integral to a single chip while others are off-chip. The chip block diagram 240 is shown as an example: other chip block diagrams and layouts may be utilized with embodiments of the present gamma correction circuit and method described herein.

In the chip block diagram 240 shown in FIG. 4, programmable gamma correction circuit 224 outputs are coupled to inputs of the source driver 222. An external resistor REXT is coupled to an input of the source driver 222. A plurality of video input signals INPUT[0] to INPUT[17] are input to a data alignment function 242. The output of the data alignment function 242 is coupled to an input of the source driver 222. A pixel clock signal PIXCLK, horizontal display signal HD, vertical display signal VD, and an input display data enable DEN signal is coupled to the input of a timing generator 244. The output of the timing generator 244 is coupled to an input of the source driver 222, and also to reference voltage control 254, gate driver control timings 256, DC/DC converter control 258, and common electrode voltage control 260, as shown.

Signals RESET and enable digital gamma function DIG_GMA are coupled to the input of control logic 246. Signals I2C serial clock SCL, I2C serial data SDA, and I2C slave address A0 are coupled to the input of serial interface 248. Signal control internal self-oscillation frequency ROSC is coupled to the input of internal oscillator 250. The chip 240 includes a field memory 230, configuration registers 226, and a fail-safe circuit 252, as shown.

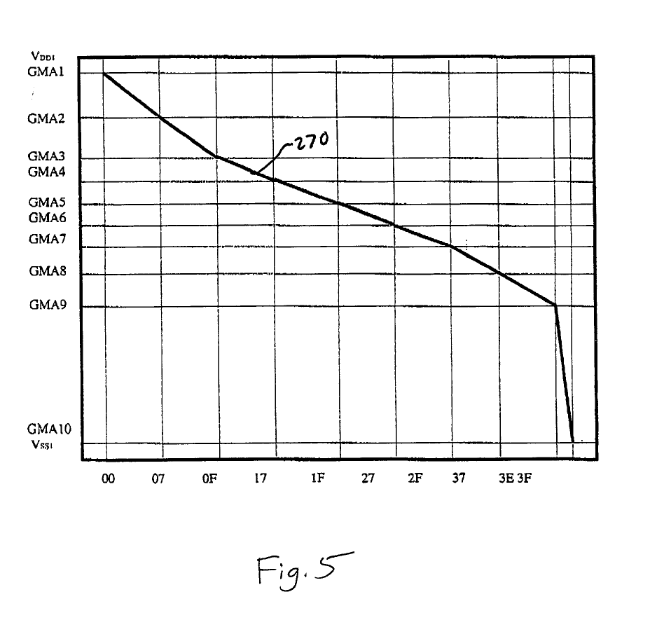

FIG. 5 shows an example of a graph of a gamma correction curve 270 in accordance with an embodiment of the invention. The x-axis indicates input video data in hexadecimal, and the y-axis indicates the reference voltages GMA1 to GMA10 corresponding to each input video data point, shown along the curve 270. The programmable gamma correction circuit 224 of embodiments of the present invention programs the GMA1 to GMA10 voltages.

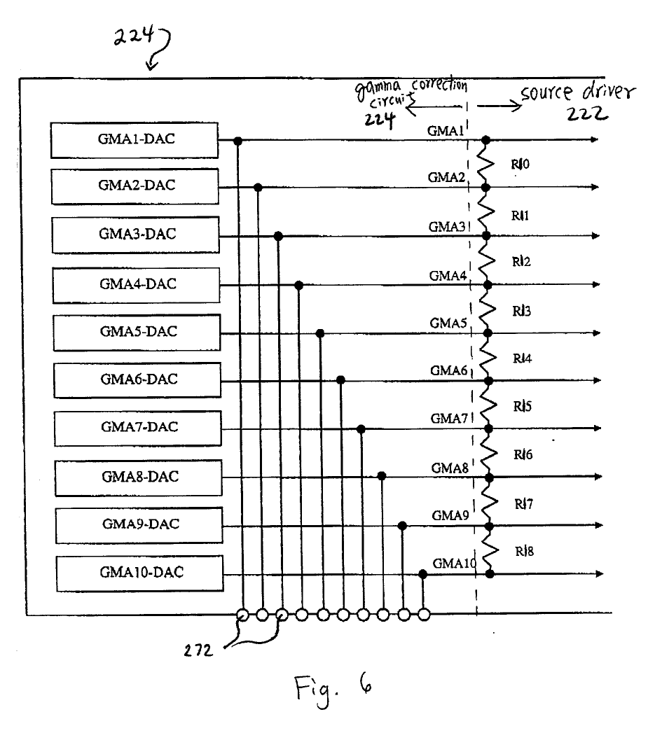

FIG. 6 illustrate the digital gamma correction circuit 224 in accordance with an embodiment of the invention, comprising ten programmable DACs that independently generate ten reference voltages. The output of the DACs are coupled to the input of the source driver 222. Optional resistors R10 through R18, each coupled between the output of adjacent GMAC's, provide a default gamma that may be used in some applications, with the digital gamma disabled using the DIG_GMA function, for example. Terminals 272 provide electrical connection to the reference voltage signals on the chip.

Embodiments of the present invention include a method of correcting gamma from video image source having an output to a display having an input. The method comprises coupling a gamma correction circuit 224 comprising a plurality of DACs to the video image source 202 output, wherein each DAC has an output. The gamma correction circuit includes a register 226 with an output coupled to provide input information to each of the DACs, wherein the output of each of the DACs provides an analog voltage which can be used for gamma correction. The method includes coupling a source driver 222 to the output of each DAC and the display 210 input.

The method may include coupling a timing controller 228 to the DACs, and coupling a memory 230 to the registers 226. The registers may comprise six bits.

While embodiments of the present invention are described herein with reference to SFF displays and display systems, they also have useful application in a variety of other display systems, such as computer systems, televisions, and projectors, as examples.

Embodiments of the present invention are advantageous in that they provide a cost and size effective means of providing gamma correction. The gamma correction circuit may be highly integrated with other circuit components of the display system. For example, the gamma correction circuit and a source driver may be integral to the same single integrated circuit chip. The circuit and method are particularly advantageous when used in SFF display systems. The gamma correction circuit provides a flexible solution, with the DAC output voltages being programmable.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description. In addition, the order of process steps may be rearranged by one of ordinary skill in the art, yet still be within the scope of the present invention. It is therefore intended that the appended claims encompass any such modifications or embodiments. Moreover, the scope of embodiments of the present application is not intended to be limited to the particular embodiments of the process, machine, manufacture, composition of matter, means, methods and steps described in the specification. Accordingly, the appended claims are intended to include within their scope such processes, machines, manufacture, compositions of matter, means, methods, or steps.

What is claimed is:

1. A gamma correction circuit comprising:
a plurality of digital-to-analog converters (DACs), each DAC having an output; and
a register with an output coupled to provide input information to each of the DACs, wherein the output of each of the DACs provides an analog voltage which can be used for gamma correction.

2. The gamma correction circuit according to claim 1, further comprising a timing controller coupled to the DACs.

3. The gamma correction circuit according to claim 1, further comprising a memory coupled to the registers.

4. The gamma correction circuit according to claim 1, wherein the registers comprise six bits.

5. The gamma correction circuit according to claim 1, further comprising a source driver coupled to each of the DAC outputs.

6. The gamma correction circuit according to claim 5, wherein the gamma correction circuit and the source driver are integral to the same integrated circuit chip.

7. The gamma correction circuit according to claim 5, wherein the gamma correction circuit comprises an input, wherein the gamma correction circuit is coupleable to a video image source at the input, wherein the source driver comprises an output, and wherein the source driver output is coupleable to a display.

8. The gamma correction circuit according to claim 7, wherein the display comprises a digital still camera, digital video camera, personal digital assistant (PDA), mobile phone, automobile television set, or liquid crystal (LCD) display.

9. The gamma correction circuit according to claim 5, wherein the source driver comprises a plurality of resistors, each resistor coupled between two adjacent DAC outputs, wherein the plurality of resistors provide an optional default gamma.

10. A display system adapted to receive an output from a video image source, the display system comprising:
a gamma correction circuit including a plurality of digital-to-analog converters (DACs) coupled to the video image source output, each DAC having an output, the gamma correction circuit including a register with an output coupled to provide input information to each of the DACs, wherein the output of each of the DACs provides an analog voltage which can be used for gamma correction;
a source driver coupled to the output of each DAC, the source driver having an output; and
a display coupled to the source driver output.

11. The display system according to claim 10, wherein the gamma correction circuit and the source driver are integral to the same integrated circuit chip.

12. The display system according to claim 10, further comprising a timing controller coupled to the DACs.

13. The display system according to claim 10, further comprising a memory coupled to the registers.

14. The display system according to claim 10, where in the registers comprise six bits.

15. The display system according to claim 10, wherein the display comprises a digital still camera, digital video camera, personal digital assistant (PDA), mobile phone, automobile television set, or liquid crystal (LCD) display.

16. The display system according to claim 10, wherein the source driver comprises a plurality of resistors, each resistor coupled between two adjacent DAC outputs, wherein the plurality of resistors provide an optional default gamma.

17. A method of correcting gamma from video image source having an output to a display having an input, comprising:
coupling a gamma correction circuit comprising a plurality of digital-to-analog converters (DACs) to the video image source output, each DAC having an output, the gamma correction circuit including a register with an output coupled to provide input information to each of the DACs, wherein the output of each of the DACs provides an analog voltage which can be used for gamma correction; and
coupling a source driver to the output of each DAC and the display input.

18. The method according to claim 17, further comprising coupling a timing controller to the DACs.

19. The method according to claim 17, further comprising coupling a memory to the registers.

20. The method according to claim 17, wherein the registers comprise six bits.

21. The method according to claim 17, wherein the display comprises a digital still camera, digital video camera, personal digital assistant (PDA), mobile phone, automobile television set, or liquid crystal (LCD) display.

22. The method according to claim 17, wherein the gamma correction circuit and the source driver are integral to the same integrated circuit chip.

23. The method according to claim 17, further comprising coupling plurality of resistors to the source driver, each resistor coupled between two adjacent DAC outputs, wherein the plurality of resistors provide an optional default gamma.
